(19) United States
(12) Patent Application Publication
(10) Pub. No.: US 2013/0198677 A1
(43) Pub. Date: Aug. 1, 2013

(54) Touchscreen Display and Navigation

(71) Applicant: Cisco Technology, Inc., San Jose, CA (US)

(72) Inventor: Samir Kumar Dash, Bangalore (IN)

(73) Assignee: CISCO TECHNOLOGY, INC., San Jose, CA (US)

(21) Appl. No.: 13/690,147

(22) Filed: Nov. 30, 2012

(30) Foreign Application Priority Data
Feb. 1, 2012 (IN) 391/CHE/2012

(51) Int. Cl. G06F 3/0488

(52) U.S. Cl. CPC G06F 3/0488
USPC 715/776

(57) ABSTRACT

A document to be displayed on a touchscreen display device is arranged to have a hierarchical structure of categories, each category including at least one sub-document. A sub-document of a first category is displayed on a touchscreen display device. A first gesture is received through the touchscreen display device. In response to the first gesture, a navigation is made to a beginning sub-document of a second category.

### FOREIGN PRIORITY

This application claims the benefit of priority of Indian Patent Application No. 391/CHE/2012, filed on Feb. 1, 2012, the contents of which are incorporated herein by reference.

### TECHNICAL FIELD

The present disclosure relates to the display and navigation of documents on a touchscreen device.

### BACKGROUND

Users interact with touchscreen devices through single touch and multi-touch gestures. A gesture may be a movement of fingers on the touch sensitive screen of a device. For a single touch gesture, a single finger is used, while a multi-touch gesture will be made using two or more fingers. A “drag” or “swipe” gesture is when a user touches the screen at one point of the screen and drags it in a particular direction while keeping the finger in contact with the screen. The “drag” or “swipe” gesture may trigger predefined events on the touchscreen device. Swipes and drags are some forms of gestures, but there are many other forms of gestures that may be supported by touchscreen devices.

Touchscreen devices are becoming ubiquitous in the consumer device market. For example, they are being used to serve as digital-book readers, music players, and general computing devices such as laptop, desktop, tablet, and smart phone computing devices. Touchscreen interface devices are also used in appliances, remote controls, and other devices such as copy and fax machines.

### BRIEF DESCRIPTION OF THE DRAWINGS

FIG. 1 illustrates a document having a hierarchical structure of categories and sub-documents.

FIG. 2 illustrates a gesture used to navigate between categories of a document on a touchscreen device.

FIG. 3 illustrates a gesture used to navigate between sub-documents on a touchscreen device.

FIG. 4 illustrates a first gesture for navigating within a sub-document on a touchscreen device.

FIG. 5 illustrates a second gesture for navigating within a sub-document on a touchscreen device.

FIG. 6a illustrates a first gesture for navigating to special categories or sub-documents within a document on a touchscreen device.

FIG. 6b illustrates a second gesture for navigating to special categories or sub-documents within a document on a touchscreen device.

FIG. 6c illustrates a third gesture for navigating to special categories or sub-documents within a document on a touchscreen device.

FIG. 6d illustrates a fourth gesture for navigating to special categories or sub-documents within a document on a touchscreen device.

FIG. 7 illustrates a touchscreen device including indicators identifying a currently displayed sub-document and category.

FIG. 8 is a flowchart illustrating a process for navigating between categories of a document

FIG. 9 is a block diagram of a touchscreen device configured to navigate between categories and sub-documents of a document.

### DESCRIPTION OF EXAMPLE EMBODIMENTS

### Overview

A document to be displayed on a touchscreen display device is arranged to have a hierarchical structure of categories, each category including at least one sub-document. A sub-document of a first category is displayed on the touchscreen display device. A first gesture is received through the touchscreen display device. In response to the first gesture, a navigation is made to a beginning sub-document of a second category.

### Example Embodiments

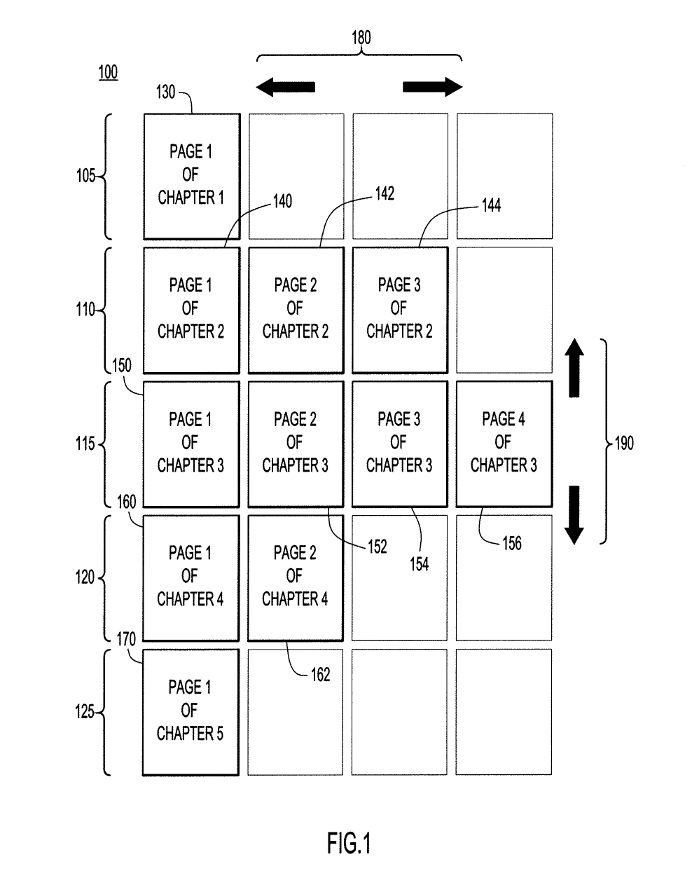

Depicted in FIG. 1 is a document 100 comprising a hierarchical structure. That is, document 100 comprises a number of categories 105-125, with each category containing one or more sub-documents 130-170. Document 100 is arranged in an M×N arrangement, where M indicates a number of categories, and N indicates the number of sub-documents within each category. Accordingly, for document 100 shown in the example of FIG. 1, M has a value of 5, and N has a range of 1 to 4, depending on which of categories 105-125 is being considered.

As indicated by horizontal arrows 180 the document 100 may, at times, be traversed by navigating between sub-documents within a single category. At other times, the document 100 may be traversed by navigating between categories within the document 100, as indicated by vertical arrows 190.

As used herein, “document” may encompass any content or other data which may be displayed on a touchscreen device. For example, document 100 may contain content for any type of work, such as a book, as well as other works including an article, web page, etc., that includes text, photographs, video for playback, audio for playback, games, etc. Accordingly, in the case of a book, each category 105-125 may comprise a chapter of the book. Contained within each chapter are sub-documents 130-170, or individual pages of each chapter. Specifically, chapter (or category) 105 contains one page (sub-document) 130. Chapter 115, on the other hand, contains four pages 150, 152, 154 and 156.

Other example documents (other than books or written documents) for which the techniques presented herein may be used include video files with chapters (categories) and scenes (sub-documents). A music collection (document) may be arranged according to albums (categories) and tracks (sub-documents). Database files may be arranged to have tables (categories) and data fields (sub-documents), or a table may serve as the document with the rows and columns of the table serving as categories and sub-documents, according to user preferences. In addition, an internet message board or blog may use these techniques, whereby individual threads may serve as categories with the posts in each thread serving as sub-documents. Web pages may also be arranged in a hierarchical structure having categories and sub-documents. For example, a news or article based website may serve as a document with different topics serving as the categories, and the individual articles serving as the sub-documents. Furthermore, a web-browser itself may serve as the document, with different tabs or browser windows serving as categories and the history of the displayed web pages serving as sub-documents. Specifically, navigating between categories will allow a user to navigate between tabs or browser windows, while navigating between sub-documents implements the web-browser's “forward” and “back” functions.

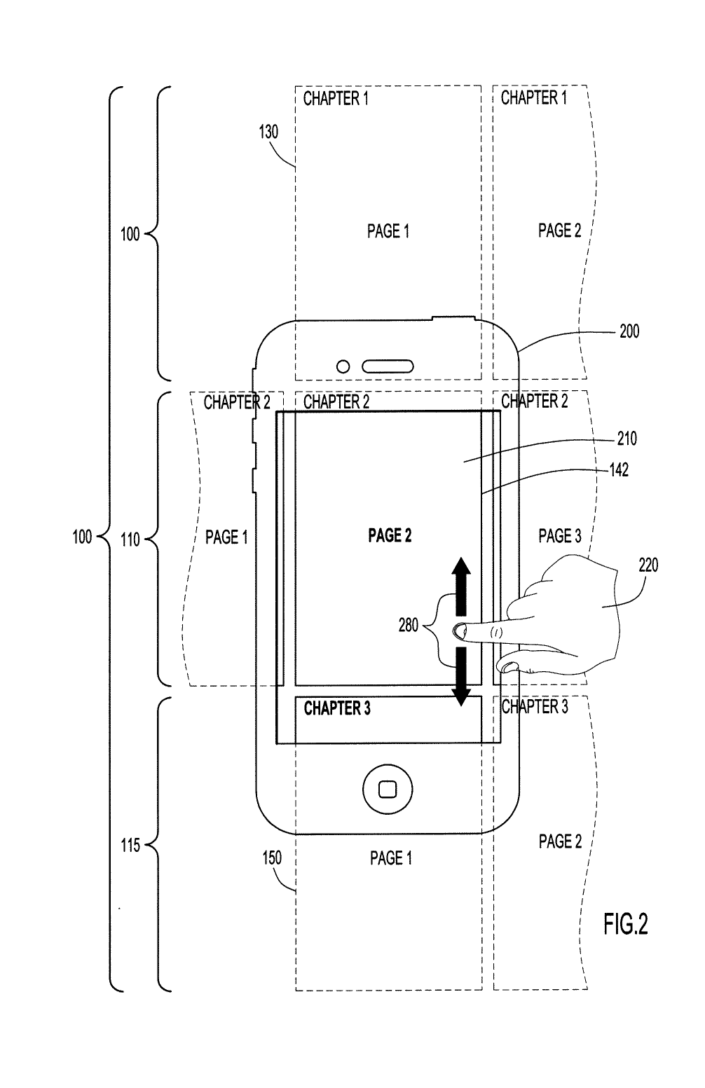

With reference now made to FIG. 2, depicted therein is a graphical diagram of a process for navigating between the categories 105-115 of a document 100. Specifically, sub-document 142 of category 110 of document 100 is displayed on touchscreen 210 of apparatus 200. In order to navigate between categories 105-115, user 220 makes a touch gesture, in this case a single touch vertical swipe, across touchscreen 210, as indicated by arrows 280. In response to the touch gesture, the display 210 will display the beginning or first sub-document of a different category, such as a category located adjacent to the present category according to the hierarchical structure of the document 100. For example, if the user 220 makes an upward vertical swipe, the touchscreen 210 may display sub-document 150 of category 115. Similarly, if the user 220 makes a downward vertical swipe, touchscreen 210 will display sub-document 130 of category 105.

It is noted that even though touchscreen 210 is not displaying the first or beginning sub-document of category 110 prior to the gesture, when the touchscreen 210 navigates to another category in response to the gesture, the first sub-document in the new category is displayed. For example, if a user is viewing the second or later pages of a chapter of a book, when the user wishes to change chapters it is more likely that the user would want to view the first page of the new chapter rather than a later page corresponding to the page in the previous chapter. Said differently, if a user is at the last page of a chapter, when they switch to another chapter, it is likely that the user would like to view the first page of the new chapter, not the last page of the new chapter. Similarly, when a user wishes to switch from one music album to another, it is expected that the user will want to start playing the first song of the new album. In the web browser context, the beginning document may correspond to the currently displayed web page, as this is where a user would begin their browsing in a new tab or window. Accordingly, touchscreen 210 will display the first or beginning sub-document of a new category in response to a gesture indicating a user's desire to change categories.

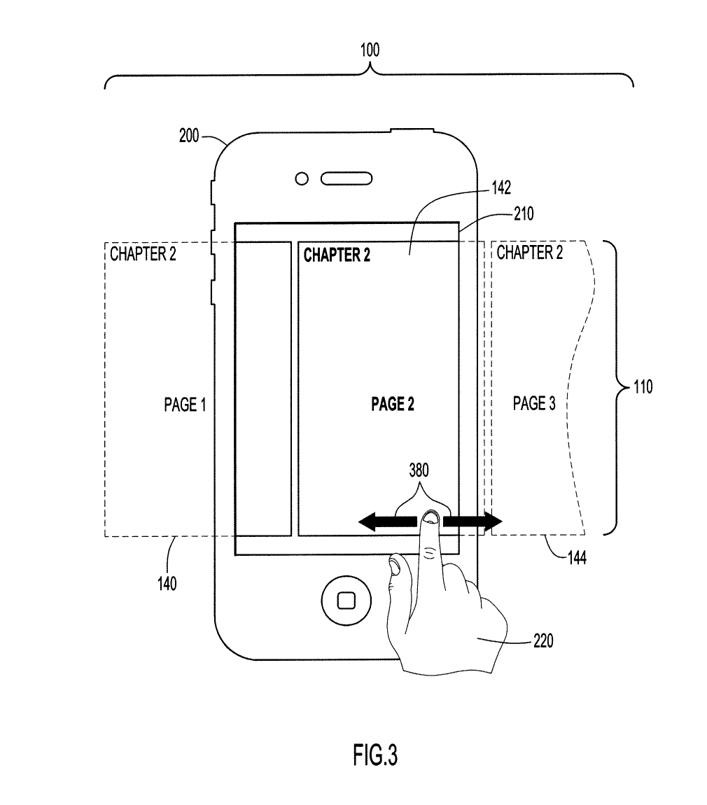

With reference now made to FIG. 3, depicted therein is a process for navigating between sub-documents within a single category of document 100. Specifically, in order to move between sub-documents 140-144, user 220 makes a second gesture different from the gesture used to navigate between sub-categories described in reference to FIG. 2. According to this example, a horizontal, single touch swipe is used to navigate between sub-documents 140-144, as indicated by horizontal arrows 380. Accordingly, a swipe made to the left will navigate away from sub-document 142 and cause touchscreen 210 to display sub-document 144. Similarly, a swipe to the right will navigate away from sub-document 142, and cause touchscreen 210 to display sub-document 140.

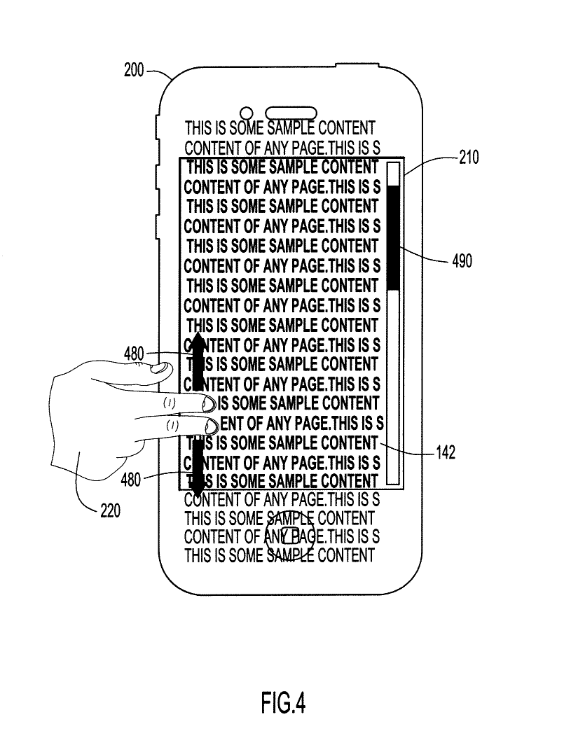

In addition to navigating between categories and sub-documents, a user may also wish to navigate within a sub-document. Accordingly, depicted in FIG. 4 is a process for navigating within sub-document 142. Specifically, user 220 will make a gesture distinct from those described with reference to FIGS. 2 and 3 in order to navigate within sub-document 142. According to this example, user 220 performs a multi-touch swipe in a vertical direction, as indicated by arrows 480. In response to the gesture, the portion of sub-document 142 which is visible on touchscreen 210 scrolls or navigates in a vertical direction. Concurrent with the gesture performed by user 220, scroll bar 490 may be displayed on touchscreen 210. Scroll bar 490 may be used to indicate to user 220 which portion of sub-document 142 is currently being displayed by touchscreen 210. As illustrated, a portion of sub-document 142 that is closer to the top of sub-document 142 than it is the bottom is currently being displayed.

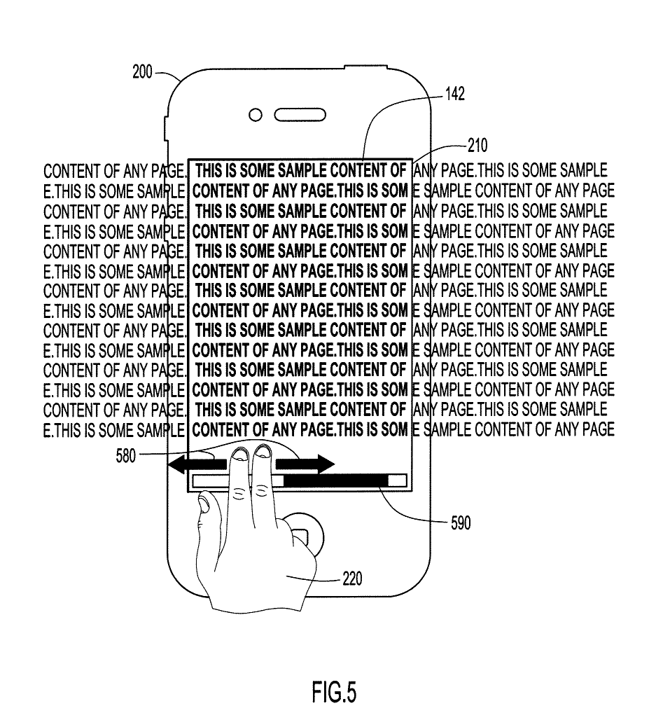

With reference now made to FIG. 5, depicted therein is another gesture performed by user 220 in order to navigate within sub-document 142. As indicated by arrows 580, user 220 is making a multi-touch gesture, in this case a swipe in a horizontal direction. In response to the gesture, the portion of sub-document 142 which is visible on touchscreen 210 scrolls or navigates in a horizontal direction. Concurrent with the gesture performed by user 220, scroll bar 590 may be displayed on touchscreen 210. Scroll bar 590 may be used to indicate to user 220 which portion of sub-document 142 is currently being displayed by touchscreen 210. As illustrated, a portion of sub-document 142 that is closer to the right hand side of sub-document 142 than it is the left hand side is currently being displayed.

In addition to the gestures depicted in FIGS. 4 and 5, additional gestures may be used to navigate within sub-document 142. For example, the user may make a gesture which indicates a desire to navigate in a direction which combines vertical and horizontal components. Specifically, a user may make a swipe in a diagonal direction. In response to such a gesture, the portion of sub-document 142 which is visible on touchscreen 210 scrolls or navigates in a diagonal direction. If, on the other hand, display 142 is already displaying an edge of sub-document 142, for example, a top edge, and the user performs a downward diagonal swipe, the navigation may take place only in the horizontal direction. Furthermore, when a gesture is made which indicates both horizontal and vertical scrolling, scroll bar 490 from FIG. 4 and scroll bar 590 from FIG. 5 may be simultaneously displayed on touchscreen 210.

Within the context of the book example or the web page example, navigating within the sub-document may comprise navigating from one portion of a page to another. In other examples, such as music and movie sub-documents, navigating within the sub-document may involve fast forwarding or rewinding within the track or scene.

While the examples of FIGS. 2-5 use single touch gestures to navigate between categories and sub-documents, and multi-touch gestures to navigate within a sub-document, the types of gestures used for these operations may be reversed. According to other examples, multi-touch gestures may be used for navigation between categories, between sub-documents, and within sub-documents. For example, two-finger gestures may be used to navigate between categories and sub-documents, while three-finger gestures may be used to navigate within sub-documents. Furthermore, the gestures used to navigate between categories and sub-documents may be differentiated, not by their direction, but by the type of gesture used to perform the navigation. For example, a two-finger horizontal gesture may navigate between sub-documents within a single category, while a three-finger horizontal gesture may navigate to the first sub-document within a different category. Similar navigation may be accomplished with vertical gestures as well.

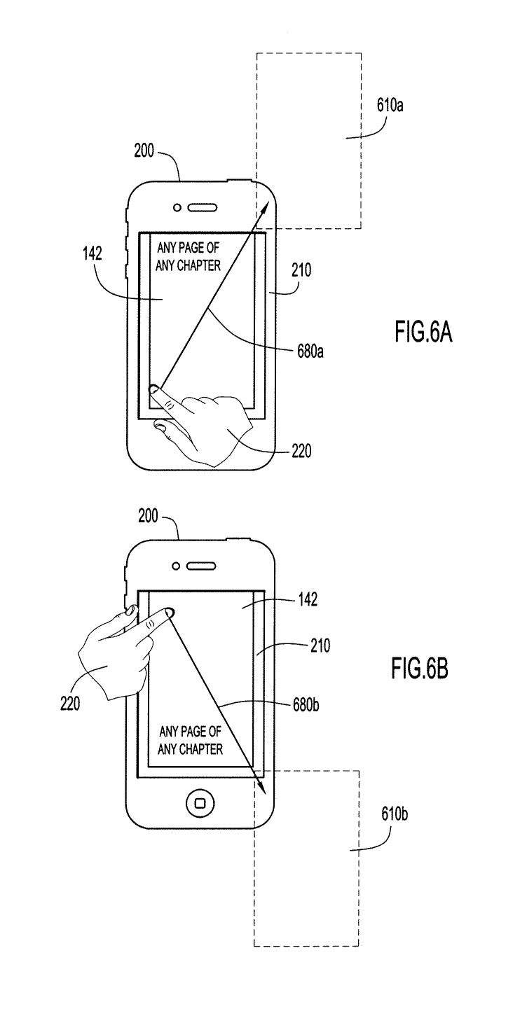

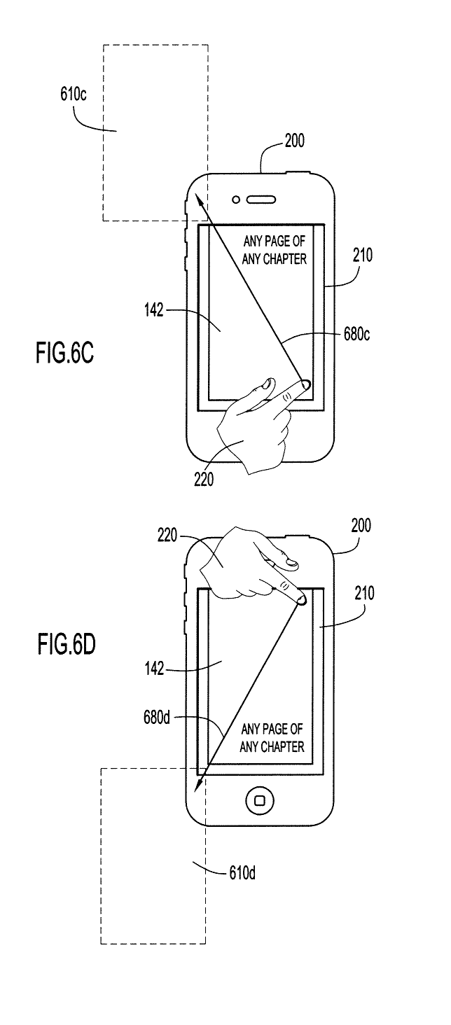

With reference now made to FIG. 6a, depicted therein is a process for navigating to portions of a document which may be of particular interest to a user. For example, academically oriented books will often locate footnotes, endnotes or annotations at the end of a chapter, and textbooks may locate problem sets at the end of a chapter. Similarly, entire books may have sections of particular importance located at the beginning or end of the book. For example, a table of contents may be located at the beginning of a book, while an index or glossary may be located at the end. Furthermore, sections like the table of contents, index and glossary are common to more than one section or chapter of a book, and therefore, a user or reader may wish to quickly navigate to these sections from every category and sub-document using the same gesture. Similarly, the apparatus 200 may allow the user to place a bookmark within an electronic book, and the user may wish to quickly return to this bookmark from any chapter or page. According to other examples, the special sections may comprise a help section, web page bookmarks or metadata. Accordingly, FIG. 6a illustrates a gesture by which a user can easily navigate to one of these special sections or portions of a document.

As indicated by arrow 680a, user 220 makes a single touch, diagonal swipe from a bottom left corner to a top right corner of touchscreen 210. In response to this gesture, the document will navigate so that section 610a is displayed on touchscreen 210. Section 610a may comprise a section which is common to more than one category or sub-document of a document, such as the table of contents, index and/or glossary of a book. Similarly, section 610a may be, for example, a scene index, an options menu, or a credit reel for a movie. In the web page example, section 610a may be a list of bookmarks, or display the browser history. According to other examples, the gesture indicated by arrow 680a may instead cause touchscreen 210 to display a first or last sub-document of a category, or immediately navigate to an initial or final sub-document for the entire document.

Because arrow 680a moves in a left to right direction, it may be intuitive to assign this gesture to cause touchscreen 210 to display sub-documents, categories or special sections which are expected to come at the beginning of a document, such as a table of contents, a title page, a scene selection menu, the opening credits, or a digital video disc or blue ray disc main menu.

FIGS. 6b-d depict additional gestures that may be used to immediately navigate to a section of the document such as the first or last sub-document in a category, the first or last sub-document in a document, or to sections of the document common to all portions of the document.

For example, because the gesture indicated by arrow 680b of FIG. 6b moves in a left to right direction, it may immediately navigate to the first sub-document of the present category as indicated by element 610b. According to another example, if the gesture indicated by arrow 680a of FIG. 6a immediately navigates to a title page represented by element 610a, the gesture indicated by arrow 680b of FIG. 6b may immediately navigate to a table contents represented by element 610b.

The gestures indicated by arrow 680c in FIG. 6c and arrow 680d in FIG. 6d may also be used to immediately navigate to a section of the document such as the first or last sub-document in a category, the first of last sub-document in a document, or to sections of the document common to all portions of the document. Yet, because arrows 680c and 680d move in a right to left direction, it may be intuitive to assign these gestures to display elements which are expected to be found at the end of documents or categories. For examples, using the example of a book, the gestures indicated by arrows 680c and 680d may be used to navigate to the glossary, the index, the last page of a current chapter, or a last page of a last chapter. On the other hand, when using the example of a movie, the gestures indicated by arrows 680c and 680d may be used navigate to a credit reel.

The gestures in FIGS. 6a-d can take forms other than the single touch diagonal swipes depicted. For example, a gesture intending to scroll within a sub-document in a diagonal direction should be distinct from a gesture performing the function described in conjunction with FIGS. 6a-d. Accordingly, scrolling in a diagonal direction may require a multi-touch gesture while performing the functions of FIGS. 6a-d may require single touch gestures. Similarly, if scrolling within a sub-document in a diagonal direction is accomplished by gesturing with two fingers, performing the functions of FIGS. 6a-d may be accomplished by gesturing with three or more fingers.

When more than one of the operations described in reference to FIGS. 2-6a-d are implemented in an single example embodiment, the gestures should be chosen so that the gestures for each operation may be distinguished from each other. Accordingly, a first distinct gesture should be used to navigate between categories as described in reference to FIG. 2. A second gesture, distinct from the first gesture, may be used to navigate between sub-documents as described in reference to FIG. 3. Similarly, a third distinct gesture may be used to navigate within a sub-document as described in FIGS. 4 and 5. Finally, a fourth gesture or set of fourth gestures distinct from the first, second and third gestures, may be used to perform the operations described in reference to FIGS. 6a-d.

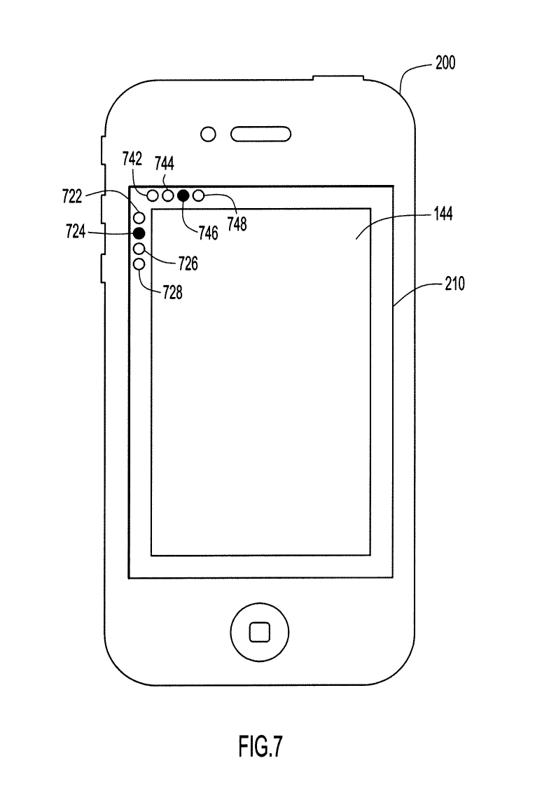

Turning to FIG. 7, depicted therein is apparatus 200 in which category indicators 722-728 and sub-document indicators 742-748 are displayed on touchscreen 210. Also displayed on touchscreen 210 is sub-document 144, which is the third sub-document of a second category. Accordingly, the third sub-document indicator 746 is highlighted, as is the second category indicator 724. These indicators, by highlighting the relative position of the sub-document within the category, and the category within the document, allow a user to quickly determine which sub-document is currently being displayed on touchscreen 210. According to the example of FIG. 7, category indicators 722-728 and sub-document indicators 742-748 take the form of individual circles or dots, with the indicator of the presently displayed category and sub-document being highlighted relative to the other indicators. In other examples, the indicators may take a different form using different shapes and methods of highlighting the currently displayed sub-document. For example, a large number of sub-documents or categories may make using individual circles cumbersome. Accordingly, the currently displayed sub-document may be indicated by other means, such as a mark along an axis.

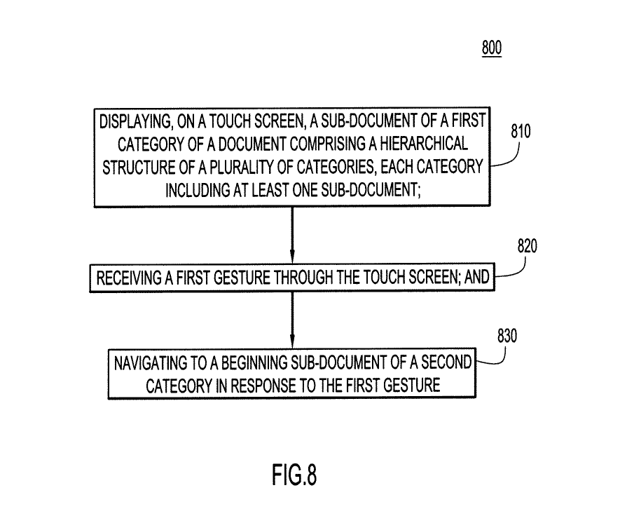

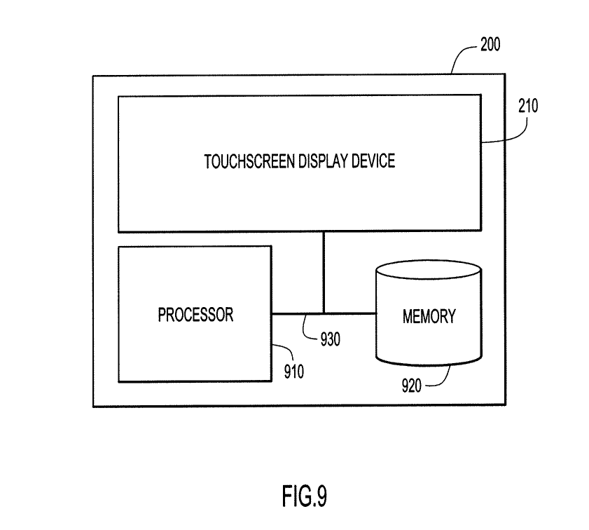

Turning to FIG. 8, depicted therein is a flowchart 800 illustrating a method of navigating between categories of a document that has a hierarchical structure. In step 810, a sub-document of a first category of a document is displayed on a touchscreen display device. The document has a hierarchical structure of a plurality of categories, which each category including at least one sub-document.

In step 820, a first gesture is received through the touchscreen display device. This first gesture may take the form of a single or multi-touch gesture. Furthermore, the gesture may take the form of swipes, taps, and other gestures that can be received through a touchscreen.

In response to having received the first gesture, a beginning sub-document of second category is navigated to in step 830. Navigating may involve determining an adjacent category to the category of the displayed sub-document, determining a beginning sub-document for the adjacent category, and displaying the beginning sub-document of the adjacent category. In response to the navigation, indicators such as those described in reference to FIG. 7 may be updated to reflect the newly displayed beginning sub-document. Subsequent to the navigation of step 830, additional navigation within the document may take place according to the techniques described above with reference to FIGS. 2-6.

With reference now to FIG. 9, depicted is an example block diagram of an apparatus configured to perform the document display and navigation techniques described herein. The apparatus 200 comprises processor 910, memory 920, bus 930 and touchscreen display device 210. Memory 920 may comprise read only memory (ROM), random access memory (RAM), magnetic disk storage media devices, optical storage media devices, flash memory devices, electrical, optical, or other physical/tangible (e.g., non-transitory) memory storage devices. The memory 920 may also store the data for the document or other content that is being displayed and navigated by the user. The processor 910 is, for example, a microprocessor or microcontroller that executes instructions. Thus, in general, the memory 920 may comprise one or more tangible (non-transitory) computer readable storage media (e.g., a memory device) encoded with software comprising computer executable instructions and when the software is executed (by the processor 910), it is operable to perform the operations described herein in connection with FIGS. 2-8.

When the techniques described herein are employed for a digital book or e-book reader application, a user can quickly navigate through the desired pages and chapters of a book. The techniques described herein eliminate the need for the user to navigate through each and every page in a chapter to move to the next or previous chapter. Similarly, it allows a user to move between chapters without referring to a table of contents, chapter index or navigation menu. In other words, the techniques described herein allow a user to navigate a document in an efficient and intuitive manner, possibly with fewer overall gestures. Furthermore, other applications of these techniques on a touchscreen device include a touchscreen device associated with a set-top boxes, video and other media equipment, music players, general computing devices such as laptop, desktop, tablet, and smart phone computing devices, and remote control devices associated therewith. Additional applications may also include touchscreen devices associated with appliances and other devices such as copy and fax machines.

The above description is intended by way of example only.

What is claimed is:

1. A method comprising
displaying, on a touchscreen display device, a sub-document of a first category of a document comprising a hierarchical structure of a plurality of categories, each category including at least one sub-document;
receiving a first gesture through the touchscreen display device; and
navigating to a beginning sub-document of a second category in response to the first gesture.

2. The method of claim 1, wherein displaying comprises displaying the document comprising a logical M×N arrangement, wherein M represents a number of categories, and N represents sub-documents within each category.

3. The method of claim 1, further comprising:
receiving a second gesture through the touchscreen, wherein the second gesture is different from the first gesture; and
navigating from the beginning sub-document to an adjacent sub-document in response to the second gesture.

4. The method of claim 3, wherein receiving the first gesture comprises receiving a vertical swipe across the touchscreen; and
wherein receiving the second gesture comprises receiving a horizontal swipe across the touchscreen.

5. The method of claim 3, further comprising:
receiving a third gesture; and
navigating within the adjacent sub-document in response to receiving the third gesture.

6. The method of claim 5, wherein:
receiving the first gesture comprises receiving a vertical, single-touch swipe;
receiving the second gesture comprises receiving a horizontal, single-touch swipe; and
receiving the third gesture comprises receiving a multi-touch gesture.

7. The method of claim 6, wherein navigating within the adjacent sub-document comprises moving the adjacent sub-document in a direction of the third gesture.

8. The method of claim 5, wherein:
receiving the first gesture comprises receiving a vertical, multi-touch swipe;
receiving the second gesture comprises receiving a horizontal, multi-touch swipe;
receiving the third gesture comprises receiving a single-touch gesture.

9. The method of claim 5, further comprising receiving a fourth gesture, wherein the fourth gesture is different from each of the first, second and third gestures; and
navigating to one of a beginning sub-document of a beginning category or a last sub-document of a last category of the document in response to receiving the fourth gesture.

10. The method of claim 9, wherein:
receiving the first gesture comprises receiving a vertical, single-touch swipe;
receiving the second gesture comprises receiving a horizontal, single-touch swipe;
receiving the third gesture comprises receiving a multi-touch gesture; and
receiving the fourth gesture comprises a diagonal single-touch swipe.

11. The method of claim 5, further comprising receiving a fourth gesture, wherein the fourth gesture is different from each of the first, second and third gestures; and
navigating to a portion of the document common to more than one category of the plurality of categories in response to receiving the fourth gesture.

12. The method of claim 11, wherein the portion of the document comprises one of a table of contents, a title page, an index, an annotations section, footnotes, bookmarks, metadata, a glossary, or a help section.

13. An apparatus comprising:
a memory configured to store data representing a document having a hierarchical structure of a plurality of categories, each category including at least one sub-document;
a touchscreen display device configured to display information and to receive touch inputs; and
a processor coupled to the memory and touchscreen display device, and configured to:
receive a first gesture through the touchscreen display device; and
navigate to a beginning sub-document of a second category in response to a first gesture while information is being displayed for a sub-document of a first category.

14. The apparatus of claim 13, wherein the processor is further configured to:
receive a second gesture through the touchscreen display device, wherein the second gesture is different from the first gesture; and
navigate from the beginning sub-document to an adjacent sub-document in response to the second gesture.

15. The apparatus of claim 14, wherein the processor is further configured to:
receive the first gesture in response to a single-touch vertical swipe across the touchscreen display device; and
receive the second gesture in response to a single-touch horizontal swipe across the touchscreen display device.

16. The apparatus of claim 15, wherein the processor is further configured to:
receive a third gesture as a multi-touch gesture; and
navigate within the adjacent sub-document in response to receiving the third gesture.

17. A tangible processor readable medium encoded with instructions that, when executed by a processor, cause the processor to:
display, on a touchscreen display device, a sub-document of a first category of a document comprising a hierarchical structure of a plurality of categories, each category including at least one sub-document;
receiving a first gesture through the touchscreen display device; and
navigating to a beginning sub-document of a second category in response to the first gesture.

18. The tangible processor readable medium of claim 17, wherein the instructions further cause the processor to:
receive a second gesture through the touchscreen display device, wherein the second gesture is different from the first gesture; and
navigate from the beginning sub-document to an adjacent sub-document in response to the second gesture.

19. The tangible processor readable medium of claim 18, wherein the instructions further cause the processor to:
receive the first gesture in response to a single-touch vertical swipe across the touchscreen display device; and
receive the second gesture in response to a single-touch horizontal swipe across the touchscreen display device.

20. The tangible processor readable medium of claim 18, wherein the instructions further cause the processor to:
receive a third gesture as a multi-touch gesture; and
navigate within the adjacent sub-document in response to receiving the third gesture.
